(19) United States
(12) Patent Application Publication
(10) Pub. No.: US 2009/0290820 A1
(43) Pub. Date: Nov. 26, 2009

(54) Linear Guideway with Retainers

(76) Inventor: Hsin-Tsun HSU, Taichung (TW)

Correspondence Address: Dr. BANGER SHIA, 102 Lindencrest Ct., Sugar Land, TX, 77479-5201, US

(21) Appl. No.: 12/123,464

(22) Filed: May 20, 2008

(51) Int. Cl. F16C 29/00

(52) U.S. Cl. 384/45

(57) ABSTRACT

A linear guideway with retainers fixes both ends of each retainer to end caps in such a manner that the retainers are installed at the inside bottom of a slide block. The retainer is provided with a retaining surface and a positioning block. The retaining surface is provided for supporting rolling elements. The positioning block is a T-shaped structure and each end of the T-shaped structure is provided with a semicircle. The positioning groove of the slide block is configured and positioned correspondingly to the positioning block and the positioning block is disposed in the positioning groove for preventing radial deformation of the retainer due to the impact of the rolling elements.

### BACKGROUND OF THE INVENTION

1. Field of the Invention

The present invention relates to fittings for a linear guideway, and more particularly to a retainer for a linear guideway.

2. Description of the Prior Art

With continuous improvement of precision feed systems, the linear transmission technology and its products have become most important part in many precision machine tools. Various linear mechanisms, such as linear guideways, have come into our daily life, in manufacturing factories and in high-tech equipments. Although the technology for linear mechanisms is developing fast, consumers still expect optimum to come. Therefore, improvement has to be made.

FIG. 1 shows a conventional retainer. The retainer 4 is installed to both sides of a bottom of a slide block 2 for retaining rolling elements B in grooves 21 of the slide block 2. Each end of the retainer 4 is provided with a positioning pillar 41 to be inserted into an inserting groove 31 of an end cap 3. A method for assembling the retainer comprises the steps of: firstly, fixing one end cap 3 at one end of the slide block 2 (by screw elements); subsequently, inserting the positioning pillar 41 of one end of the retainer 4 into one end cap 3; and finally, inserting the positioning pillar 41 of the other end of the retainer 4 into the other end cap 3 and fixing the end caps 3 to the end surfaces of the slide block 2, thus finishing the assembly of the retainer 4. However, the structure associated with assembly method for this conventional retainer 4 and the end caps 3 has the following problems:

1. During disassembling and assembling process, the retainer can only be disassembled and assembled by removing the end caps first, so the disassembling and assembling process is relatively complicated.

2. Since there is no fixing structure in the middle of the retainer, if the retainer is too long, a radial deformation will occur, causing the disengagement of the rolling elements.

Hence, the conventional retainer cannot achieve the function of quick release, and the problem to be urgently improved is that, since there is no fixing structure in the middle of the retainer, if the retainer is too long, the radial deformation is likely to occur, the rolling elements cannot be retained in the grooves of the guideway, namely, the retainer loses its function of retaining the rolling elements.

In order to solve the above problems, U.S. Pat. No. 6,939,045 disclosed a retainer having a positioning block extended from the middle portion thereof. The positioning block is provided with a positioning pillar. A slide block includes a groove corresponding to the positioning block for disposing the positioning block. The slide block further includes a positioning hole corresponding to the positioning pillar for insertion of the positioning pillar, so as to avoid the radial deformation of the retainer, thus preventing malfunction of the retainer. However, the disadvantage of this conventional technology is that, two machining procedures are required for forming the groove and the positioning hole of the slide block. The first machining procedure is using a milling cutter to form the groove. The second machine procedure is changing the milling cutter into a drill to machine the positioning hole (CNC tool changing generally takes about 20 seconds). Thus, this conventional technology needs two kinds of tools to machine the slide block, and a lot of time will be wasted when performing a mass production of slide blocks, thus virtually increasing the manufacturing cost.

The present invention has arisen to mitigate and/or obviate the afore-described disadvantages.

### SUMMARY OF THE INVENTION

The primary objective of the present invention is to provide a linear guideway with retainers, which can reduce the machining procedures of the slide block (reduce CNC tool changing procedures) and reduce the manufacturing cost.

In order to achieve the above objectives, the linear guideway with retainers of the present invention comprises:

A slide rail is provided with a plurality of rolling grooves at both sides thereof.

A slide block is mounted on the slide rail and provided with a rolling channel corresponding to the rolling grooves of the slide rail, the slide block has a plurality of axial circulating holes and has a positioning groove at each side of a bottom thereof.

Two end caps are installed on both end surfaces of the slide block, and each end cap is provided with a plurality of circulating channels, both ends of the respective circulating channel are linked with the circulating holes, the rolling grooves and the rolling channel.

A plurality of rolling elements is installed between the rolling grooves and the rolling channel.

Two retainers are fixed on the end caps by both ends thereof in such a manner that the retainers are installed to an inside bottom of the slide block, each retainer is provided with a retaining surface and a positioning block, the retaining surface is provided for supporting the rolling elements, the positioning block is a T-shaped structure provided with a semicircle at each end thereof (the semicircle is provided for matching with the profile of the tool and the machining path, so as to reduce the manufacturing cost, and other configurations such as: an ellipse, a straight line segment each end of which is connected with a quarter circle, or a square can also be applied onto the positioning block, but the machining cost is relatively increased). The positioning groove of the slide block is configured and positioned correspondingly to the positioning block, and the positioning block is disposed in the positioning groove for preventing radial deformation of the retainer due to impact of the rolling elements.

It is to be noted that, the positioning block of the retainer and the positioning groove of the slide block are designed to be T-shaped configurations through careful thought. Because the positioning groove of the slide block is the T-shaped structure, the CNC machining only needs one kind of tool (for example, end milling cutter) to finish the machining of the positioning groove. Thus, such a configuration can greatly shorten the machining time of the slide block (being compared to the conventional technology, the present invention can save about 20 seconds). In view of the mass production, much more manufacturing time will be saved, so the present invention relatively reduces the manufacturing cost of the slide block.

### BRIEF DESCRIPTION OF THE DRAWINGS

FIG. 1 is an exploded view showing a conventional slide block, conventional retainers, end caps and rolling elements;

FIG. 2 is an exploded view showing a slide block, retainers, end caps and rolling elements in accordance with a first embodiment of the present invention;

FIG. 3 shows the relation between the slide block and the retainers in accordance with the first embodiment of the present invention;

FIG. 4 is a cross-sectional view of the positioning grooves of the slide block and the positioning blocks of the retainers in accordance with the first embodiment of the present invention;

FIG. 5 is a perspective view of the retainer in accordance with the first embodiment of the present invention;

FIG. 6 shows the relation between slide block and the retainer in accordance with a second embodiment of the present invention;

FIG. 7 shows the relation between the end caps and the retainers in accordance with the second embodiment in accordance with the present invention;

FIG. 8A is a front view of the end cap in accordance with the second embodiment of the present invention;

FIG. 8B is a cross-sectional view along the line A-A of FIG. 8A;

FIG. 9 is a perspective view of the retainer in accordance with the second embodiment of the present invention;

FIG. 10 shows the relation between the end caps and the retainers in accordance with the third embodiment of the present invention;

FIG. 11A is a front view of the end cap in accordance with the third embodiment of the present invention;

FIG. 11B is a cross-sectional view along the line A-A of FIG. 11A; and

FIG. 12 is a perspective view of the retainer in accordance with the third embodiment of the present invention.

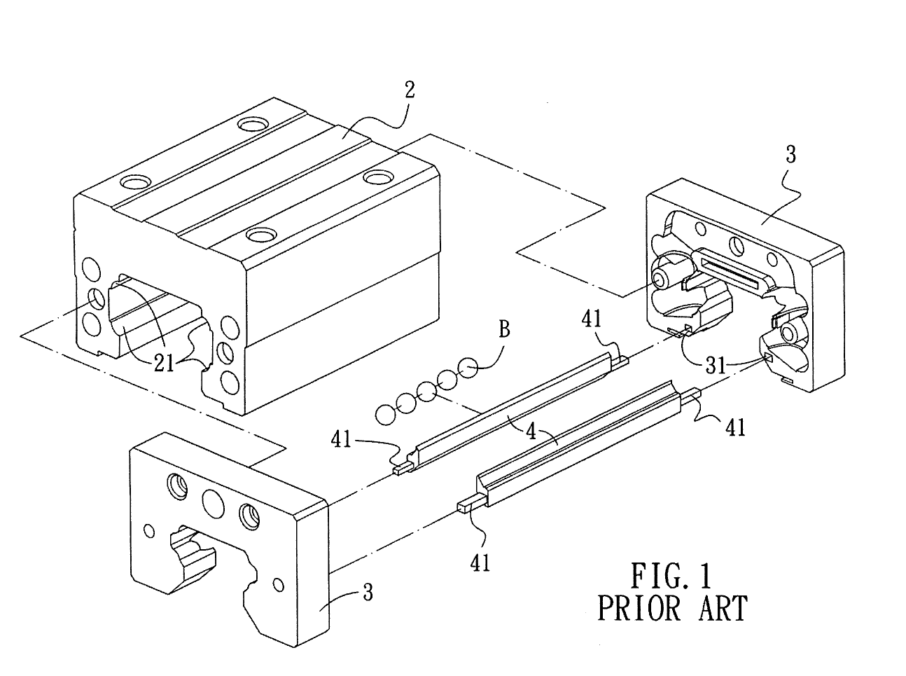

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

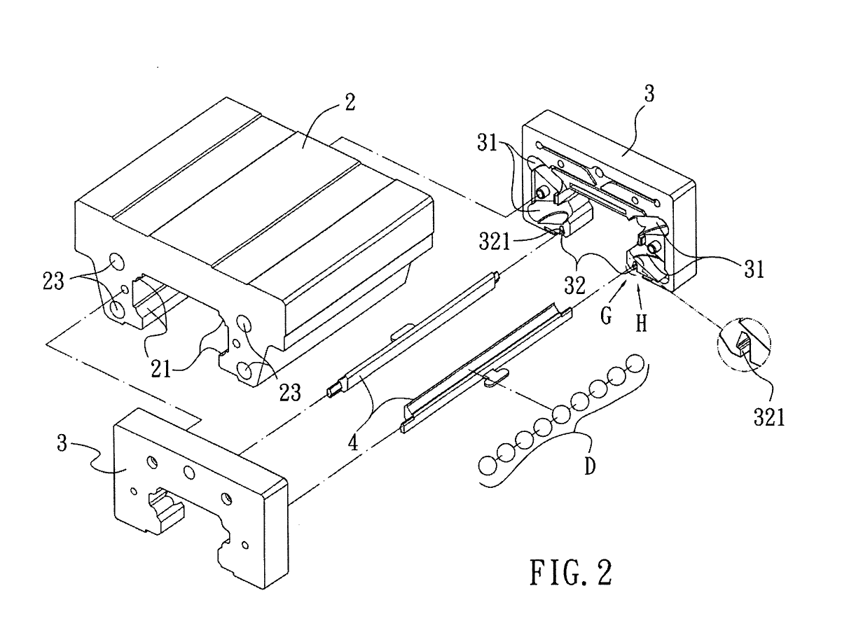

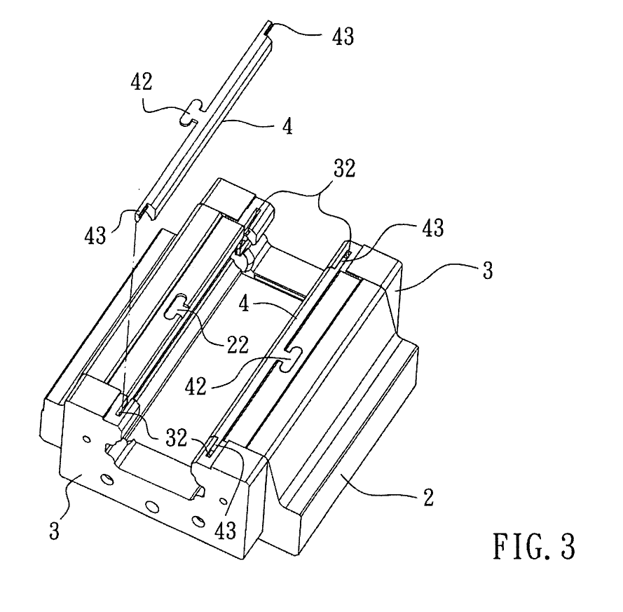

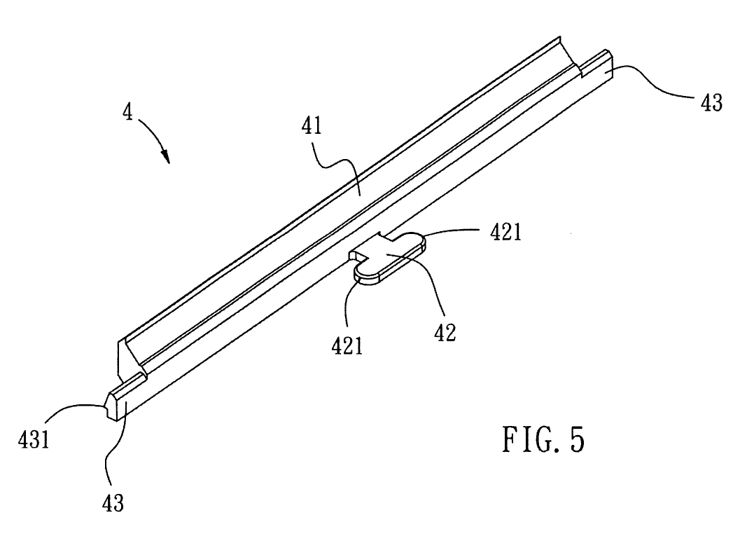

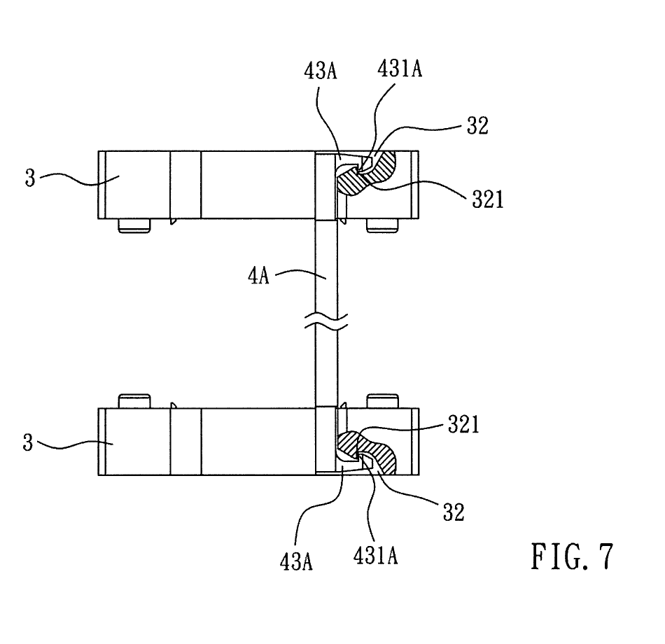

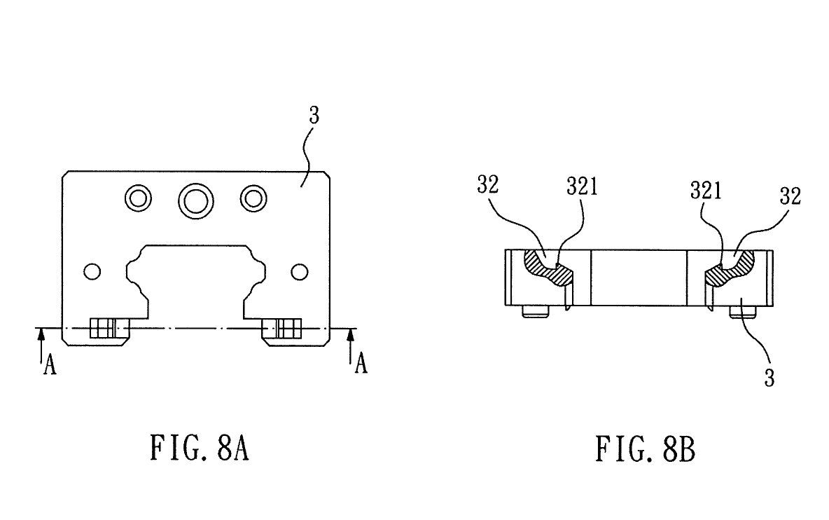

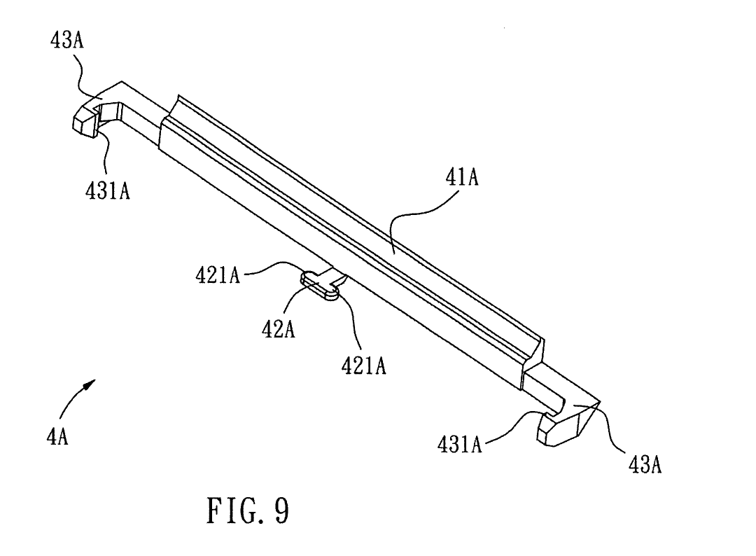

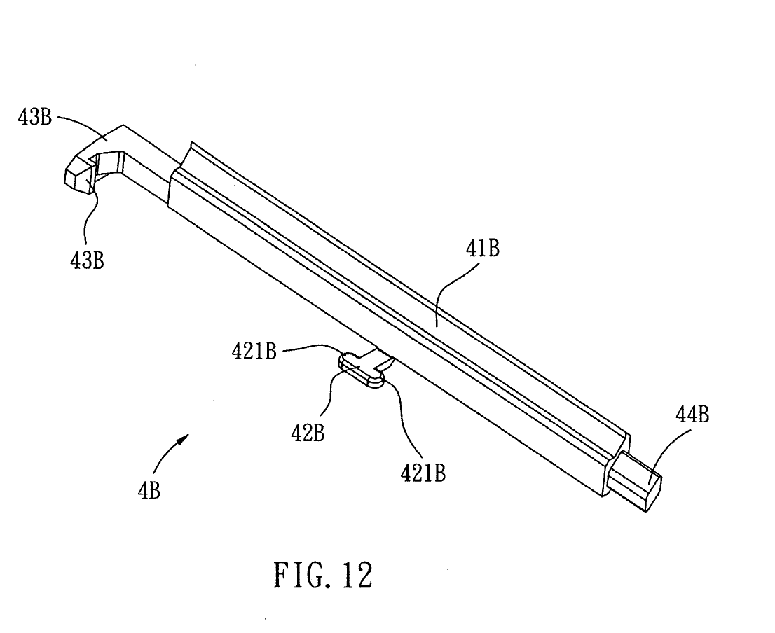

Referring to FIGS. 2-12, a linear guideway with retainers in accordance with the present invention comprises a slide rail 1, a slide block 2, two end caps 3, a plurality of rolling elements D and two retainers 4, 4A, 4B.

The slide rail 1 is provided with a plurality of rolling grooves 11 at both sides thereof.

The slide block 2 is mounted on the slide rail 1 and is provided with a rolling channel 21 corresponding to the rolling grooves 11 of the slide rail. Further, the slide block 2 is provided with a plurality of axial circulating holes 23, and is further provided with a positioning groove 22 at each side of the bottom thereof.

The two end caps 3 are installed on both end surfaces of the slide block 2. Each end cap 3 is provided with a plurality of circulating channels 31. Both ends of the respective circulating channels 31 are linked with the circulating holes 23, the rolling grooves 11 and the rolling channel 21.

The plurality of rolling elements D is installed between the rolling grooves 11 and the rolling channel 21.

Both ends of the retainers 4, 4A, 4B are fixed to the end caps 3 in such a manner that the retainers 4, 4A, 4B are installed at the inside bottom of the slide block 2. Each retainer 4, 4A, 4B is provided with a retaining surface 41, 41A, 41B and a positioning block 42, 42A, 42B. The retaining surface 41, 41A, 41B is provided for supporting the rolling elements. The positioning block 42, 42A, 42B is a T-shaped structure. Each end of the T-shaped structure is provided with a semicircle 421, 421A, 421B. The positioning groove 22 of the slide block 2 is configured and positioned correspondingly to the positioning block 42, 42A, 42B. The positioning block 42, 42A, 42B is disposed in the positioning groove 22.

The aforementioned is the summary of the positional and structural relationship of the respective components of the present invention, and the preferred embodiments in accordance with the present invention are described as follows.

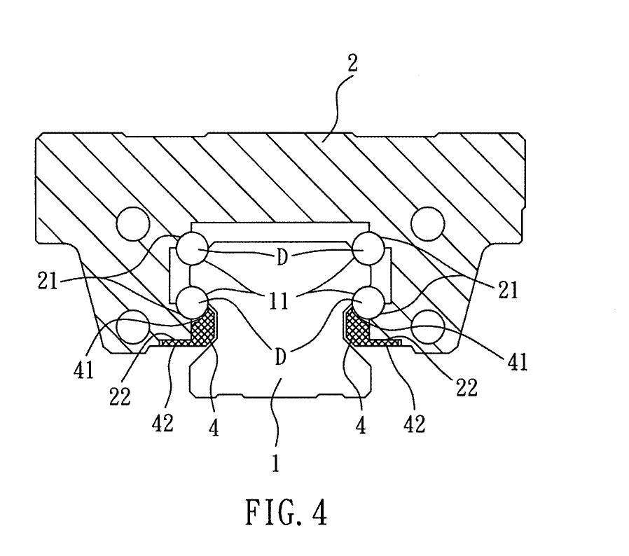

FIGS. 2-5 show a first embodiment in accordance with the present invention. Each side of the bottom of the end cap 3 is provided with a fixing groove 32 which extends from the bottom H and the inner end surface G inwards. The fixing groove 32 includes an inner protrusion 321. Each end of the retainer 4 is provided with an elongated positioning pillar 43 which includes a hook portion 431. When the retainer 4 is installed, the positioning pillar 43 is fixed in the fixing groove 32. With the engagement of the hook portion 431 with the protrusion 321, the positioning block 42 of the retainer 4 is synchronously disposed in the positioning groove 22 of the slide block 2. Further referring to FIG. 4, the retainer 4 utilizes the retaining surface to support the rolling elements D for preventing the rolling elements D from disengaging from the slide block 2.

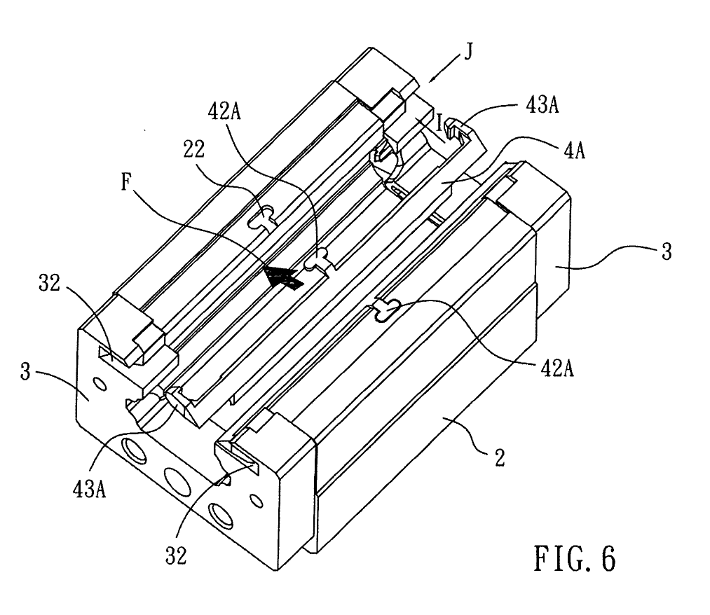

FIGS. 6-9 show a second embodiment in accordance with the present invention. The main difference between the present embodiment and the first embodiment is that: each end of the retainer 4A is provided with an L-shaped fixing portion 43A which includes a hook portion 431A, each side of the end cap 3 is provided with a fixing groove 32 which extends from the outer end surface J and the inside surface I inwards and includes a protrusion 321. Referring to FIG. 6, when the retainer 4A is installed, the fixing portions 43A at both ends of the retainer 4A are fixed in the positioning grooves 32 along the installing direction F. With the engagement of the hook portion 4A with the positioning block 42A, the positioning block 42A of the retainer 4A is synchronously disposed in the positioning groove 22 of the slide block 2.

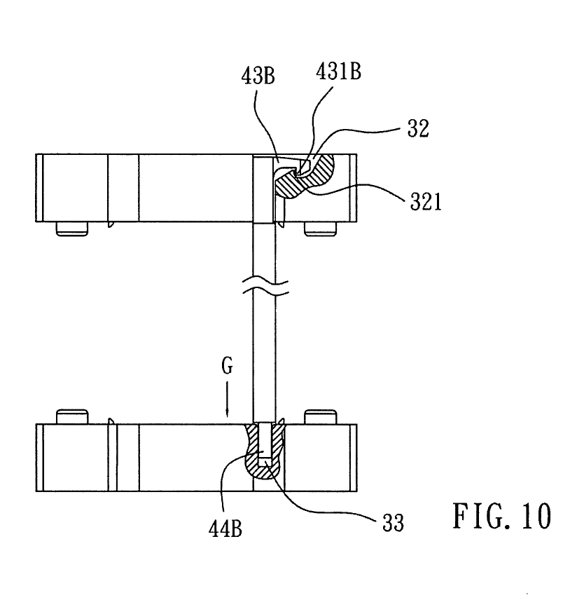

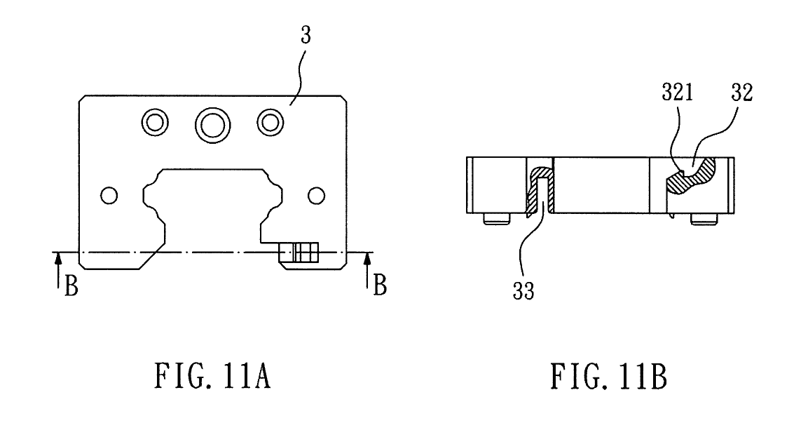

FIGS. 10-12 show a third embodiment in accordance with the present invention. The main difference between the third embodiment and the second embodiment is that: one end of the retainer 4B is provided with a positioning pillar 44B, and the other end of the retainer 4B is provided with the same fixing portion 43B as that of the second embodiment (this structure is the same as the second embodiment, so further explanations will be omitted here). Referring to FIG. 11B, one side of the end cap 3 is provided with a positioning hole 33 extending from an inner end surface G inwards, and the other side of the end cap 3 is provided with the same fixing groove 32 as that of the second embodiment (this structure is the same as the second embodiment, further explanations will be omitted here). When the retainer 4B is installed, the positioning pillar 44B of the retainer 4B is inserted into the positioning hole 33 of the end cap 3, and then the fixing portion 43B is fixed in the fixing groove 32, and the hook portion 431B is engaged with the protrusion 321. At the same time, the positioning block 42B of the retainer 4B is synchronously disposed in the positioning groove 22 of the slide bock 2.

Additionally, as for all the embodiments of the present invention, at the time of assembling the slide block, the retainer can be installed after the two end caps are installed to both end surfaces of the slide block. Thus, the assembly time can be shortened, relatively reducing the manufacturing cost. The retainer is made by plastic injection molding, which is suitable for mass production.

While we have shown and described various embodiments in accordance with the present invention, it is clear to those skilled in the art that further embodiments may be made without departing from the scope of the present invention.

What is claimed is:

1. A linear guideway with retainers, comprising:
a slide rail provided with a plurality of rolling grooves at both sides thereof;
a slide block mounted on the slide rail and provided with a rolling channel corresponding to the rolling grooves of the slide rail, the slide block having a plurality of axial circulating holes and having a positioning groove at each side of a bottom thereof;
two end caps installed on both end surfaces of the slide block and each end cap provided with a plurality of circulating channels, both ends of the respective circulating channel being linked with the circulating holes, the rolling grooves and the rolling channel;
a plurality of rolling elements installed between the rolling grooves and the rolling channel; and
two retainers, the two retainers being fixed on the end caps by both ends thereof in such a manner that the retainers are installed to an inside bottom of the slide block, each retainer being provided with a retaining surface and a positioning block, the retaining surface being provided for supporting the rolling elements, the positioning block being a T-shaped structure provided with a semicircle at each end thereof, the positioning groove of the slide block being configured and positioned correspondingly to the positioning block, and the positioning block being disposed in the positioning groove.

2. A linear guideway with retainers, comprising:
a slide rail provided with a plurality of rolling grooves at both sides thereof;
a slide block mounted on the slide rail and provided with a rolling channel corresponding to the rolling grooves of the slide rail, the slide block having a plurality of axial circulating holes and having a positioning groove at each side of a bottom thereof;
two end caps installed on both end surfaces of the slide block, and each end cap provided with a plurality of circulating channels, both ends of the respective circulating channels being linked with the circulating holes, the rolling grooves and the rolling channel;
a plurality of rolling elements installed between the rolling grooves and the rolling channel; and
two retainers, the two retainers being fixed on the end caps by both ends thereof in such a manner that the retainers are installed to an inside bottom of the slide block, each retainer being provided with a retaining surface and a positioning block, the retaining surface being provided for supporting the rolling elements, the positioning block being a T-shaped structure, the positioning groove of the slide block being configured and positioned correspondingly to the positioning block, and the positioning block being disposed in the positioning groove.

3. The linear guideway with retainers as claimed in claim 2, wherein both ends of the T-shaped structure of the positioning block are provided with an ellipse.

4. The linear guideway with retainers as claimed in claim 2, wherein both ends of the T-shaped structure of the positioning block are provided with a straight line segment each end of which is connected with a quarter circle.

5. The linear guideway with retainers as claimed in claim 1, wherein both ends of the T-shaped structure of the positioning block are provided with a square.

6. The linear guideway with retainers as claimed in claim 1, wherein each side of a bottom of the end cap is provided with a fixing groove extending from the bottom and an inner end surface inward, the fixing groove including an inner protrusion, each end of the retainer is provided with an elongated fixing pillar having a hook portion, the fixing pillars at both ends of the retainer are fixed in the fixing grooves, and the retainer is fixed by engaging the hook portion with the protrusion.

7. The linear guideway with retainers as claimed in claim 2, wherein each side of a bottom of the end cap is provided with a fixing groove extending from the bottom and an inner end surface inward, the fixing groove including an inner protrusion, each end of the retainer is provided with an elongated fixing pillar having a hook portion, the fixing pillars at both ends of the retainer are fixed in the fixing grooves, and the retainer is fixed by engaging the hook portion with the protrusion.

8. The linear guideway with retainers as claimed in claim 1, wherein each side of a bottom of the end cap is provided with a fixing groove extending from an outer surface and an inside surface inward, the fixing groove is provided with an inner protrusion, both ends of the retainer are provided with two L-shaped fixing portions, an end of the fixing portion is provided with a hook portion, the fixing portions at both ends of the retainers are fixed in the fixing grooves, and the retainer is fixed by engaging the hook portion with the protrusion.

9. The linear guideway with retainers as claimed in claim 2, wherein each side of a bottom of the end cap is provided with a fixing groove extending from an outer surface and an inside surface inward, the fixing groove is provided with an inner protrusion, both ends of the retainer are provided with two L-shaped fixing portions, an end of the fixing portion is provided with a hook portion, the fixing portions at both ends of the retainers are fixed in the fixing grooves, and the retainer is fixed by engaging the hook portion with the protrusion.

10. The linear guideway with retainers as claimed in claim 1, wherein one side of the end cap is provided with a positioning hole extending from an inner end surface, and the other side of the end cap is provided with a fixing groove extending an outer surface and an inside surface inward, the fixing groove is provided with an inner protrusion, one end of the retainer is provided with a positioning pillar and the other end of the retainer is provided with an L-shaped fixing portion, an end of the fixing portion is provided with a hook portion, the positioning pillar of the retainer is inserted in the positioning hole of the end cap, the fixing portion is fixed in the fixing groove, and the retainer is fixed by engaging the hook portion with the protrusion.

11. The linear guideway with retainers as claimed in claim 2, wherein one side of the end cap is provided with a positioning hole extending from an inner end surface, and the other side of the end cap is provided with a fixing groove extending an outer surface and an inside surface inward, the fixing groove is provided with an inner protrusion, one end of the retainer is provided with a positioning pillar and the other end of the retainer is provided with an L-shaped fixing portion, an end of the fixing portion is provided with a hook portion, the positioning pillar of the retainer is inserted in the positioning hole of the end cap, the fixing portion is fixed in the fixing groove, and the retainer is fixed by engaging the hook portion with the protrusion.

12. The linear guideway with retainers as claimed in claim 1, wherein the retainer is made by plastic injection molding

13. The linear guideway with retainers as claimed in claim 2, wherein the retainer is made by plastic injection molding.

14. The linear guideway with retainers as claimed in claim 3, wherein the retainer is made by plastic injection molding.
